(19) United States
(12) Patent Application Publication
(10) Pub. No.: US 2014/0016486 A1
(43) Pub. Date: Jan. 16, 2014

(54) Fabric Cell Packing in a Switch Device

(71) Applicant: Golan Schzukin, Herzliya (IL)

(72) Inventor: Golan Schzukin, Herzliya (IL)

(73) Assignee: Broadcom Corporation, Irvine, CA (US)

(21) Appl. No.: 13/547,837

(22) Filed: Jul. 12, 2012

(51) Int. Cl. H04L 12/64; H04L 12/26

(52) U.S. Cl. 370/252; 370/355

(57) ABSTRACT

A method and system can insert multiple packets into a fabric cell. The method or system may be implemented as part of a line card on a switch device. The line card may obtain multiple packets with common packing characteristics, such as destination device, destination port, or priority. The line card may then determine if the multiple packets meet insertion criteria, such as whether the multiple packets together can fit into a fabric cell supported by a switching fabric in the switch device. When the insertion criteria is satisfied, the line card may insert data from the multiple packets into a fabric cell prior to switching the fabric cell through the switching fabric.

### TECHNICAL FIELD

This disclosure relates to networking devices such as a switch. More specifically, this disclosure relates to inserting packets into a fabric cell for communication across a switching fabric in the switching device.

### BACKGROUND

Rapid advances in electronics and communication technologies, driven by immense user demand, have resulted in vast interconnected networks of computing devices capable of exchanging immense amounts of data. For example, Local Area Networks (LANs) may connect hundreds or thousands of computing devices in a single network. Perhaps the best known example of such interconnection of computing devices is the Internet, which continues to expand with each passing day. As technology continues to advance and interconnected communication networks grow in size and frequency of use, there is an increasing incentive to send and receive data more efficiently.

### BRIEF DESCRIPTION OF THE DRAWINGS

The innovation may be better understood with reference to the following drawings and description. In the figures, like reference numerals designate corresponding parts throughout the different views.

FIG. 1 shows an example of a system for fabric cell packing.

FIG. 2 shows an example of a system for fabric cell packing.

FIG. 3 shows an example of a system for fabric cell packing.

FIG. 4 shows an example of a system for fabric cell packing.

FIG. 5 shows an example of a system for fabric cell packing.

FIG. 6 shows an example of a system for fabric cell packing.

FIG. 7 shows an example of logic that the line card may implement as hardware, software, or both.

FIG. 8 shows an example of a system for unpacking a fabric cell.

FIG. 9 shows an example of logic that the line card may implement as hardware, software, or both.

### DETAILED DESCRIPTION

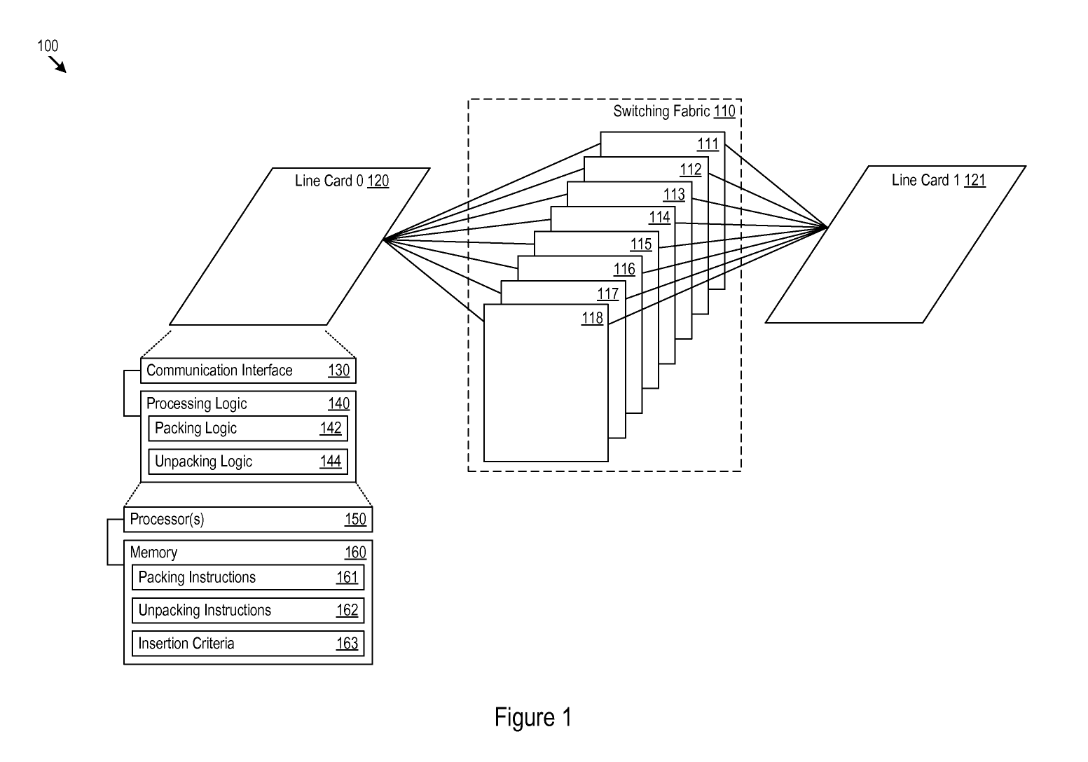

FIG. 1 shows an example of a system 100 for fabric cell packing. The system 100 may be implemented as part of a network device for communicating, processing, or routing data through a communications network. For example, the system 100 may be implemented as part of a switch, hub, router, gateway, network bridge, or any other type of network device that processes or routes network data such as packets. The system 100 may communicate network data according to any number of communication protocols, topologies, or technologies, including as examples, Ethernet, Digital Subscriber Line (DSL), Integrated Services Digital Network (ISDN), Fiber Distributed Data Interface (FDDI), and others.

The system 100 includes the switching fabric 110. The switching fabric 110 may be used to route network data, e.g., packets, between ports or other interfaces on a switch, to which network segments, nodes, or devices may be connected. The switching fabric 110 may be implemented in any number ways, including, as examples, a single stage Clos network, a multi-stage Clos network, or other implementations. The switching fabric 110 may include any number of fabric planes, such as the eight fabric planes 111-118 shown in the exemplary system 100. In one implementation, the switching fabric 110 may communicate network data in the form of fabric cells from input ports to output ports of the system 100, and thereby between devices communicatively coupled to the switching fabric 110. The switching fabric 110 may communicate network data in the form of fabric cells. A fabric cell may vary in size and may contain any amount of network data from one or more packets received, e.g., at the input ports. In other words, the fabric cell implements a transport mechanism for the switching fabric 110 that may be independent of the size or format of the packets received by or transmitted out of the system 100. The range of sizes and the format of the fabric cell may be determined in advance as a design parameter of the system 100. However, in other implementations, the range of sizes or format of a fabric cell may be dynamic in nature, changing during operation of the system 100.

The switching fabric 110 may support fabric cells that range between a minimum fabric cell size and a maximum fabric cell size. For example, the switching fabric 110 may support a minimum fabric cell size of 64 bytes and a maximum fabric cell size of 256 bytes. A fabric cell may include a fabric cell header that includes information describing the fabric cell. Examples of information that may be included in a fabric cell header include a fabric cell size, a destination device, a fabric cell priority, number of packets included in the fabric cell, length of each included packet, checksum or error correction information for the fabric cell, or other information.

The switching fabric 110 may route fabric cells containing packet data to and from any number of devices, for example line cards in a switch device. Two examples of line cards are depicted in FIG. 1 and labeled as line card 0 120 and line card 1 121. The line cards 120-121 may interface with one or several network devices in a communication network. The line cards 120-121 may receive and process network data from any number of the network devices interfaced with the line cards 120-121. The line cards 120-121 may also transmit network data to any number of the network devices interfaced with the respective line card. In one implementation, the line cards 120-121 may receive and send network data as data packets, which may vary in packet size and content according to any number of communication protocols.

Line card 0 120 may include a communication interface 130 for sending network data to the switching fabric 110, receiving network data from the switching fabric 110, or both. As an example, the line card 0 120 may communicate network data in the form of a fabric cell that the switching fabric 110 processes, e.g., routes, to a destination line card. Line card 0 120 may also include processing logic 140. The processing logic 140 may include packing logic 142 and unpacking logic 144. In one implementation, the processing logic 140 includes one or more processors 150 and a memory 160 that stores packing instructions 161, unpacking instructions 162, and insertion criteria 163.

As described in greater detail below, the packing logic 142 may determine a fabric cell size of a fabric cell and insert data from one or more packets into the fabric cell without exceeding the fabric cell size. The packing logic 142 may determine any fabric cell size that may be supported by the switching fabric 110. The unpacking logic 144 may receive a fabric cell and determine if data from multiple packets are packed, e.g., inserted, into the fabric cell. The unpacking logic 144 may separate the data from the multiple packets for processing by the line card.

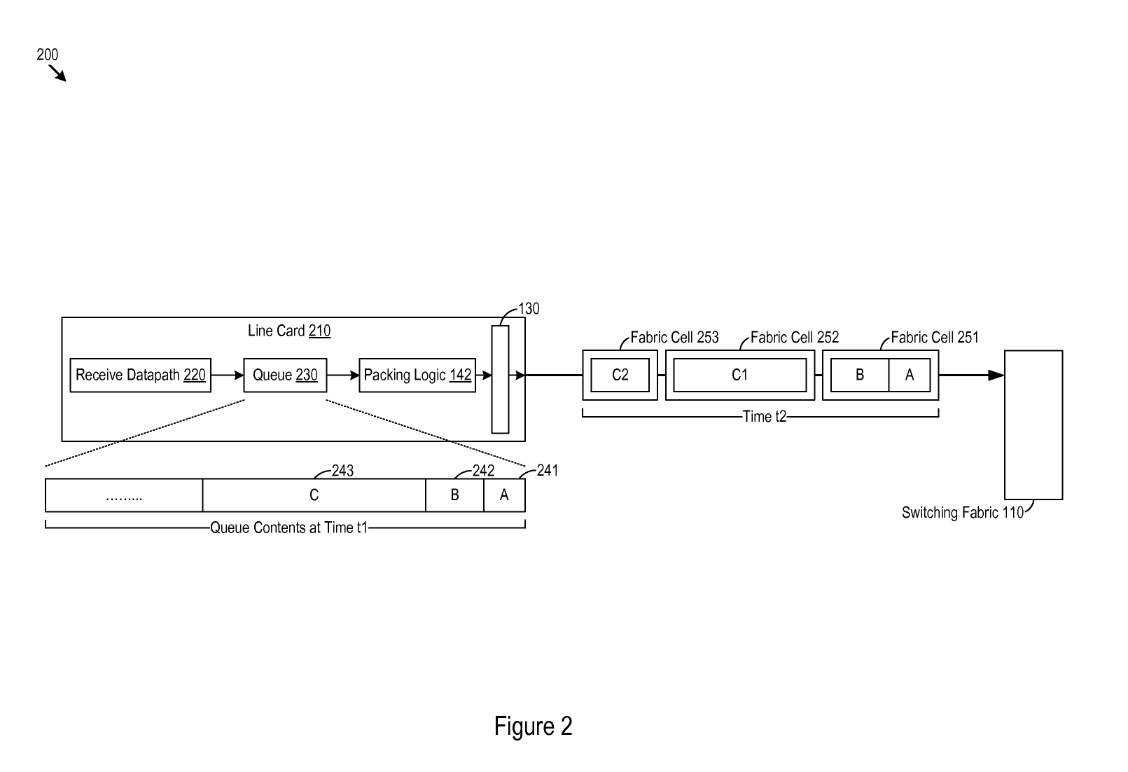

FIG. 2 shows an example of a system 200 for fabric cell packing. The system 200 includes the line card 210, which may include the receive datapath 220. The receive datapath 220 may contain any amount of logic to process packets received by the line card 210, e.g., from a network device interfaced with the line card 210. For example, the receive datapath 220 may determine a destination device or destination line card a packet may be routed to.

The line card 210 may also include a buffer operable to store packets. For example, the line card 210 may include any number of queues, such as the queue 230 shown in FIG. 2. The queue 230 may store packets processed by the receive datapath 220. The line card 210 may separate packets processed by the receive datapath 220 according to any number of packet characteristics. A packet characteristic may specify any characteristic of a packet, including, for example, a destination device, destination port, transmission priority, quality of service requirement, or any combination thereof. In one implementation, the line card 210 may store packets in different queues according to one or more packing characteristics. For example, the line card 210 may store packets sharing the same destination device packing characteristic within the one or more queues, e.g., the queue 230. In one example, each of the packets in the queue 230 may be directed to the same destination device, e.g., line card in a switch, a network device, or other destination.

The queue 230 may store any number of packets. As seen in FIG. 2, the queue 230 stores packet A 241, packet B 242, and packet C 243 at a time t1. Packet A 241 may be positioned at the head of the queue 230, followed sequentially afterwards by packet B 242 and then packet C 243. The queue 230 shown in FIG. 2 may store additional packets at time t1 as well. Packets A-C may vary in packet size. The packing logic 142 may obtain one or more fabric cells storing packet data from packets received by the line card 210, e.g., the packets A-C. For example, the packing logic 142 may create one or more fabric cells to send packet data, e.g., data from packets A-C, for switching through the switching fabric 110.

The packing logic 142 may insert data from multiple packets into a fabric cell. In one implementation, the packing logic may insert data from multiple packets into a fabric cell when the multiple packets meet insertion criteria, such as the insertion criteria 163. The insertion criteria 163 may include criteria with respect to one or more packing characteristics of the multiple packets. For instance, the insertion criteria 163 may be that the multiple packets share a common destination port, destination device, transmission priority, or any combination thereof. The packing logic 142 may obtain multiple packets with common packing characteristics by dequeuing packets from one or more queue storing packets with one or more common packing characteristics, e.g., from the queue 230.

The insertion criteria 163 may also include criteria with respect to a fabric cell, such as that a first packet is smaller than the fabric cell, a second packet is smaller than the fabric cell, the first packet and second packet together are smaller than the fabric cell, or other criteria. The insertion criteria 163 may also be that any number of packets under consideration for packing fit within a fabric cell without exceeding the maximum fabric cell size of the fabric cell. The insertion criteria 163 may also be that the amount of data from multiple packets does not exceed a maximum amount of data a fabric cell can hold.

As one illustrative example, the insertion criteria 163 may be that multiple packets fit within a fabric cell supported by the switching fabric 110. In FIG. 2, the switching fabric 110 may support, for example, a minimum fabric cell size of 64 bytes and a maximum fabric cell size of 256 bytes. The contents of the queue 230 at time t1 may include packet A 241 with a packet size of 64 bytes, packet B 242 with a packet size of 96 bytes, and packet C 243 with a packet size of 384 bytes. The packing logic 142 may obtain packet A 241, for example by dequeuing packet A 241 from the queue 230. The packing logic 142 may determine that packet A 241 has a packet size (e.g., 64 bytes) that is less than the maximum fabric cell size supported by the switching fabric 110 (e.g., 256 bytes). Next, the packing logic 142 may obtain packet B 242 and determine that packet A 241 (e.g., 64 bytes) and packet B 242 (e.g., 96 bytes) together contain 160 bytes of data, which is less than the maximum fabric cell size supported by the switching fabric 110. The packing logic 142 may thus determine that packet A 241 and packet B 242 meet the insertion criteria and may be packed into a fabric cell, e.g., a packed fabric cell.

In one implementation, the packing logic 142 may continue to obtain packets until the combined size of the obtained packets exceeds the maximum fabric cell size supported by the switching fabric 110. In the example above, the packing logic 142 may obtain packet C 243 and determine that packet A 241 (e.g., 64 bytes), packet B 242 (e.g., 96 bytes), and packet C 243 (384 bytes) together contain 655 bytes of data, which exceeds the maximum fabric cell size supported by the switching fabric 110 (e.g., 256 bytes). Thus, the packing logic 142 may determine that packet A 241 and packet B 242 may be combined into a fabric cell, while separately processing packet data from packet C 243 into one or more fabric cells.

When the packing logic 142 has determined that multiple packets meet the insertion criteria 163, the packing logic 142 may create a fabric cell to send the multiple packets for switching through the switching fabric 110. The packing logic 142 may determine a fabric cell size such that the multiple packets fit within the fabric cell. The packing logic 142 may also insert the data from the multiple packets, e.g., packet A 241 and packet B 242, into the fabric cell. In the example shown in FIG. 2, the packing logic 142 creates the fabric cell 251, which includes packet A 241 and packet B 242. A fabric cell containing data from multiple packets may be referred to as a packed fabric cell, whether or not the fabric cell is of maximum size.

In one implementation, the packing logic 142 may insert separation data between packet data contained in a packed fabric cell. For example, the packing logic 142 may insert a symbol or control word to separate packet data, such as a Serializer/Deserializer (SerDes) encoded (e.g., 8B/10B or 64B/66B) control word. The packing logic 142 may insert the separation data while creating the packed fabric cell, e.g., subsequent to inserting data from first packet and prior to inserting data from a second packet.

In one implementation, the packing logic 142 may create a cell header based on the multiple packets in the fabric cell. For example, the cell header may include fabric cell size data that reflects the amount of data stored in the fabric cell. In one implementation, the cell header may include a multiple packet field that identifies whether the fabric cell includes multiple packets. The multiple packet field may be implemented as a single bit denoting whether the fabric cell includes data from multiple packets. Alternatively, the multiple packet field may specify the number of packets contained in the fabric cell or other multiple packet information, e.g., a starting position of a second packet in the fabric cell. The packing logic 142 may also create a cell header when a fabric cell includes a single packet or a selected portion of a single packet, such as when a packet exceeds the maximum fabric cell size supported by the switching fabric 110. The cell header may be used during the cell unpacking process

Continuing the example above, the packing logic 142 may create one or more fabric cells for switching the packet data from packet C 243 through the switching fabric 110. The packing logic 142 may obtain packet C 243 and determine that packet C does not satisfy an insertion criteria 163 because the 384 bytes of data from packet C 243 exceeds the 256 byte maximum fabric cell size supported by the switching fabric 110. Accordingly, the packing logic 142 may separate packet C 243 into multiple fabric cells. In FIG. 2, the packing logic 142 creates the fabric cell 252, which may include a selected first portion of data from packet C 243, and the fabric cell 253, which may include a second portion of data from packet C 243. For example, the fabric cell 252 may include the first 256 bytes of data from packet C 243 and the fabric cell 253 may include the second 128 bytes of data from the packet C 243. In one implementation, the packet logic 142 maintains the order of packets, the order of data in a packet, or both, when creating fabric cells for switching through the switching fabric 110.

After a fabric cell is created by the packing logic 142, the line card 210 may send the fabric cell for switching through the switching fabric 110 via the communication interface 130. As seen in the example shown in FIG. 2, the data from packets A-C is sent from the communication interface 130 at time t2 as the fabric cells 251-253.

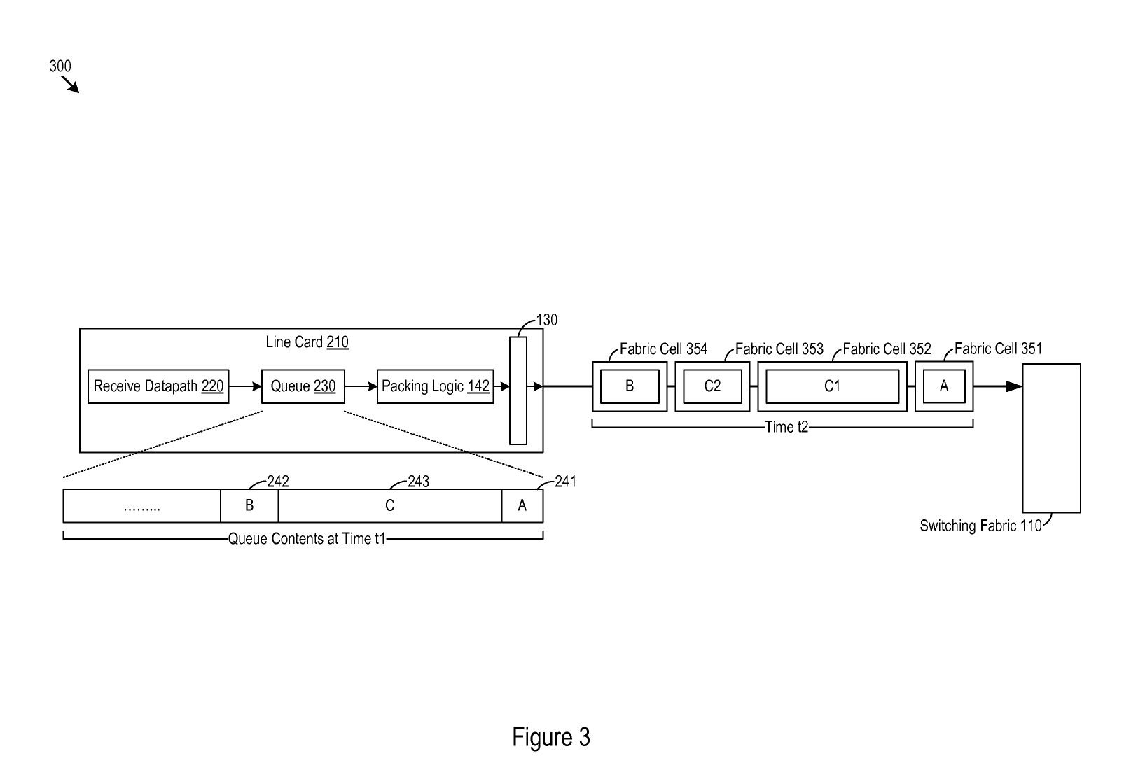

FIG. 3 shows another example of a system 300 for fabric cell packing. As seen in FIG. 3, the queue 230 stores packet data, including, at a time t1, packet A 241 at the head of the queue 230 followed sequentially afterwards by packet C 243 and then packet B 242. Similar to the example above, packet A 241 includes 64 bytes of data, packet C 243 includes 384 bytes of data, and packet B 242 includes 96 bytes of data. Also as with the example above, the switching fabric 110 may support a minimum fabric cell size of 64 bytes and a maximum fabric cell size of 256 bytes.

In FIG. 3, the insertion criteria 163 may be that multiple packets fit within a fabric cell supported by the switching fabric 110. The packing logic 241 may obtain packet A 241 and determine that packet A 241 has a packet size (64 bytes) that is less than the 256 byte maximum fabric cell size supported by the switching fabric 110. The packing logic 142 may then obtain packet C 243 and determine that packet A 241 (64 bytes) and packet C 243 (384 bytes) together contain 448 bytes, thus exceeding the 256 byte maximum fabric cell size. As packets A 241 and C 243 do not meet the insertion criteria 163, the packing logic 142 may create a fabric cell that includes the 64 bytes of data from packet A 241, seen in FIG. 3 as the fabric cell 351. The packing logic 142 may also create multiple fabric cells to send the 384 bytes of data from packet C 243. In FIG. 3, the packing logic 142 obtains the fabric cell 352, which may include a selected first 256 bytes of data from packet C 243, and the fabric cell 353, which may include the remaining 128 bytes of data from packet C 243. The packing logic 142 may also create a fabric cell to send the 96 bytes of data from packet B 242, seen in FIG. 3 as the fabric cell 354.

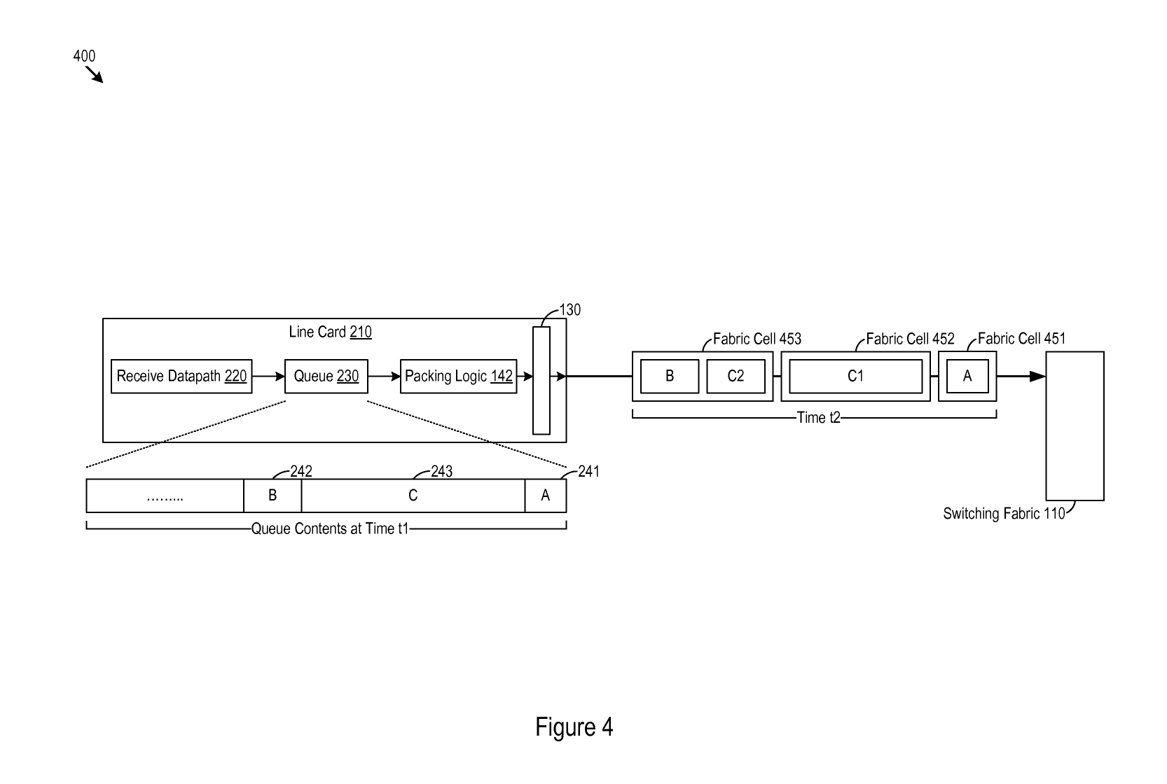

FIG. 4 shows an example of a system 400 for fabric cell packing. As seen in FIG. 4, the queue 230 stores packet data, including packet A 241 at the head of the queue 230 followed sequentially by packet C 243 and then packet B 242. Similar to the example above, packet A 241 includes 64 bytes of data, packet C 243 includes 384 bytes of data, and packet B 242 includes 96 bytes of data. Also as with the example above, the switching fabric 110 may support a minimum fabric cell size of 64 bytes and a maximum fabric cell size of 256 bytes.

In one implementation, the packing logic 142 may combine a selected portion of data from a packet with data from any number of other packets. For example, the packing logic 142 may include insertion criteria 163. The insertion criteria 163 may be that a portion of data from a first packet and a second packet fit within a fabric cell supported by the switching fabric 110. In FIG. 4, the packing logic 142 may separate data from packet C 243 into multiple fabric cells, including the fabric cell 452 which may include a first 256 byte portion of data from packet C 243. The packing logic 142 may then determine that the remaining 128 bytes of data from packet C 243 and the 96 bytes of data from packet B 242 can fit into a fabric cell supported by the switching fabric 110, e.g., without exceeding a 256 byte maximum fabric cell size. Then, the packing logic 142 may create a fabric cell and insert the second 128 byte portion of data from packet C 243 and the 96 bytes of data from packet B 242 into the fabric cell. As seen in FIG. 4, the fabric cell 453 includes a second portion of data from packet C 243 as well as packet B 242.

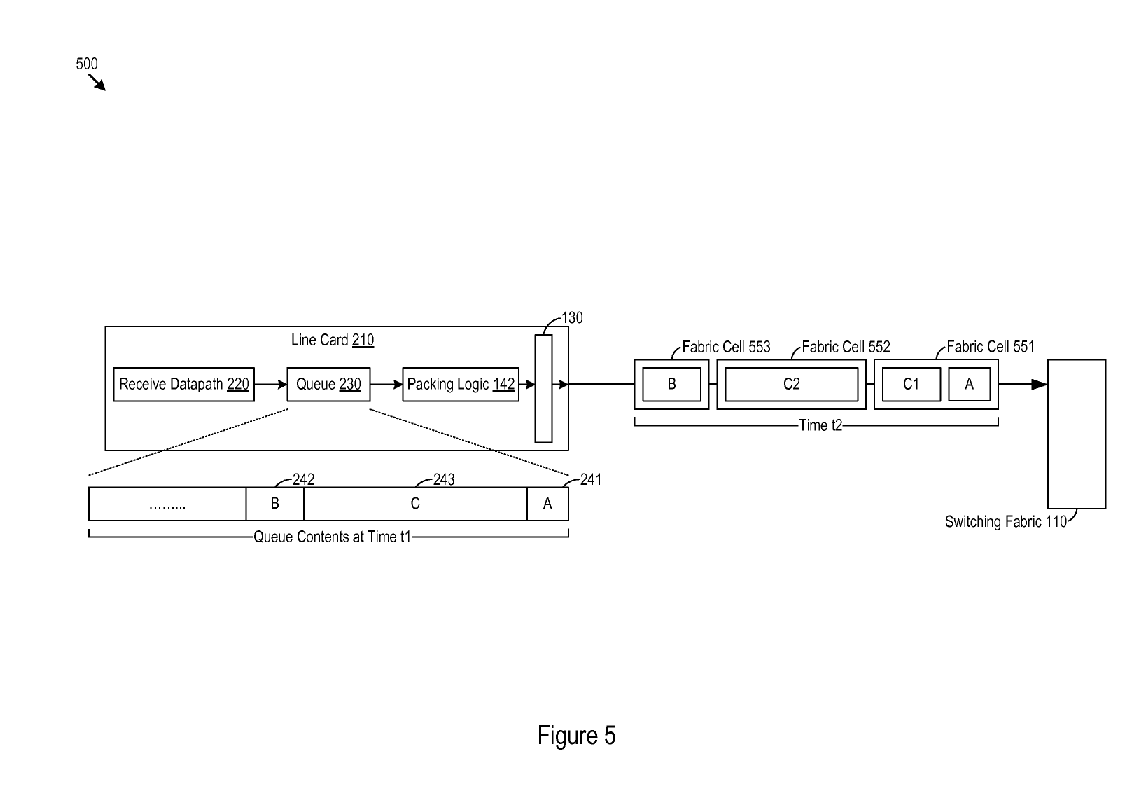

FIG. 5 shows an example of a system 500 for fabric cell packing. The packing logic 142 may include insertion criteria 163. The insertion criteria 163 may be that a first packet and a portion of data from a second packet fit within a fabric cell supported by the switching fabric 110. In this example, the packing logic 142 may insert packet A 241, which may include 64 bytes of data, and a selected first portion of packet C 243 into a fabric cell, e.g., the fabric cell 551 shown in FIG. 5. The packing logic 142 may determine a fabric cell size such that packet A 241 and a selected portion of packet C 243 fit into the fabric cell. In one implementation, the packing logic 142 may determine the fabric cell size as the maximum fabric cell size supported by the switching fabric 110. In this implementation, the fabric cell 551 includes the 64 bytes of data from packet A 241 and 192 bytes of data from a selected first portion of packet C 243. The packing logic 142 may also create one or more fabric cells containing the remaining data from a packet, e.g., the packet C 243. In FIG. 5, the fabric cell 552 may include the 192 bytes of the remaining portion of data from packet C 243.

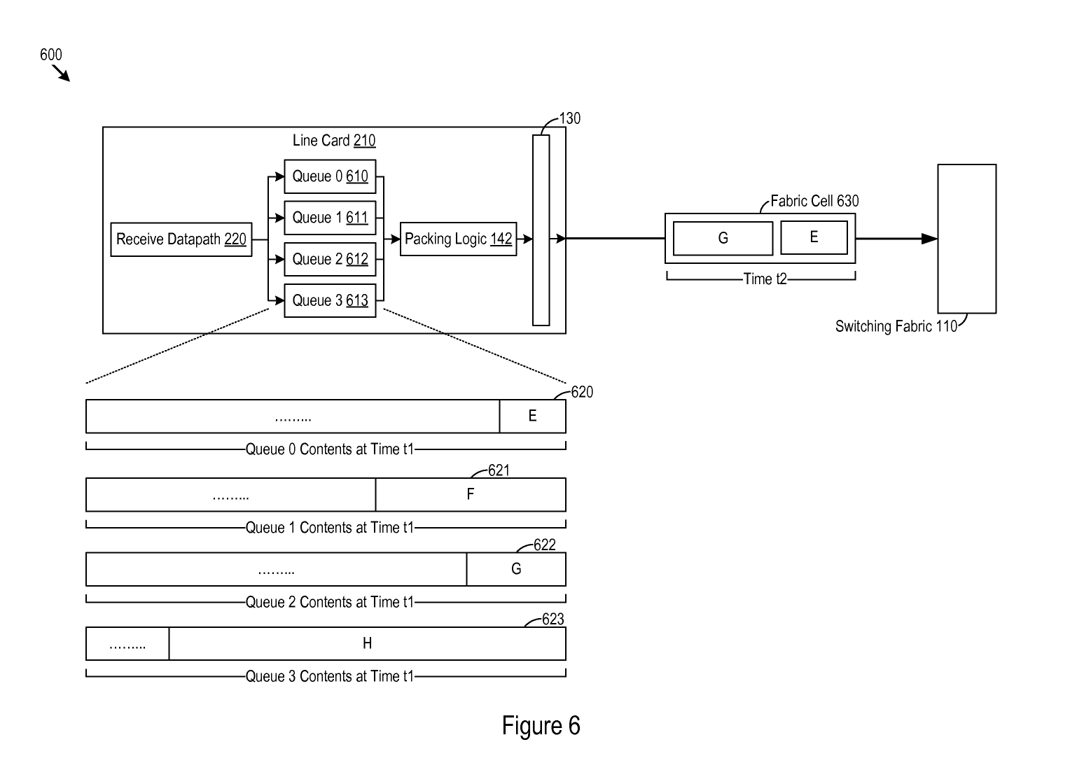

FIG. 6 shows an example of a system 600 for fabric cell packing. The line card 210 shown in FIG. 6 includes multiple queues, including the four queues labeled as queue 0 610, queue 1 611, queue 2 612, and queue 3 613. The queues 610-613 may include packets sharing one or more common packing characteristics. For example, the queues 610-613 may each store packets that share any combination of a common destination device, destination port, transmission priority, or other packing characteristics. At a time t1, queue 0 610 may store packet E 620, queue 1 611 may store packet F 621, queue 2 612 may store packet G 622, and queue 3 613 may store packet H 623.

In one implementation, the packing logic 142 may insert packets from multiple queues into a fabric cell. For example, the packing logic 142 may obtain multiple packets from multiple queues sharing a common packing characteristic. The packing logic 142 may then determine if the obtained multiple packets meet insertion criteria with respect to a fabric cell, e.g., whether any combination of the multiple packets can be combined into a fabric cell with a fabric cell size supported by the switching fabric 110.

In the example shown in FIG. 6, queues 610-613 may store packets with a common destination device and transmission priority. Packet E 620 may be 96 bytes in length, packet F 621 may be 384 bytes in length, packet G may be 128 bytes in length, and packet H 623 may be 8 Kilobytes in length. The packing logic 142 may determine that packet E 620 and packet G 622 together contain 224 bytes of data, which is less than the 256 byte maximum fabric cell size supported by the switching fabric 110. The packing logic 142 may then insert data from packets E 620 and G 622 into a fabric cell for switching through the switching fabric 110, seen in FIG. 6 as the fabric cell 630. The packing logic 142 in FIG. 6 may also insert data from portions of multiple packets as well, for example, according to any of the examples discussed in FIGS. 2-5 above.

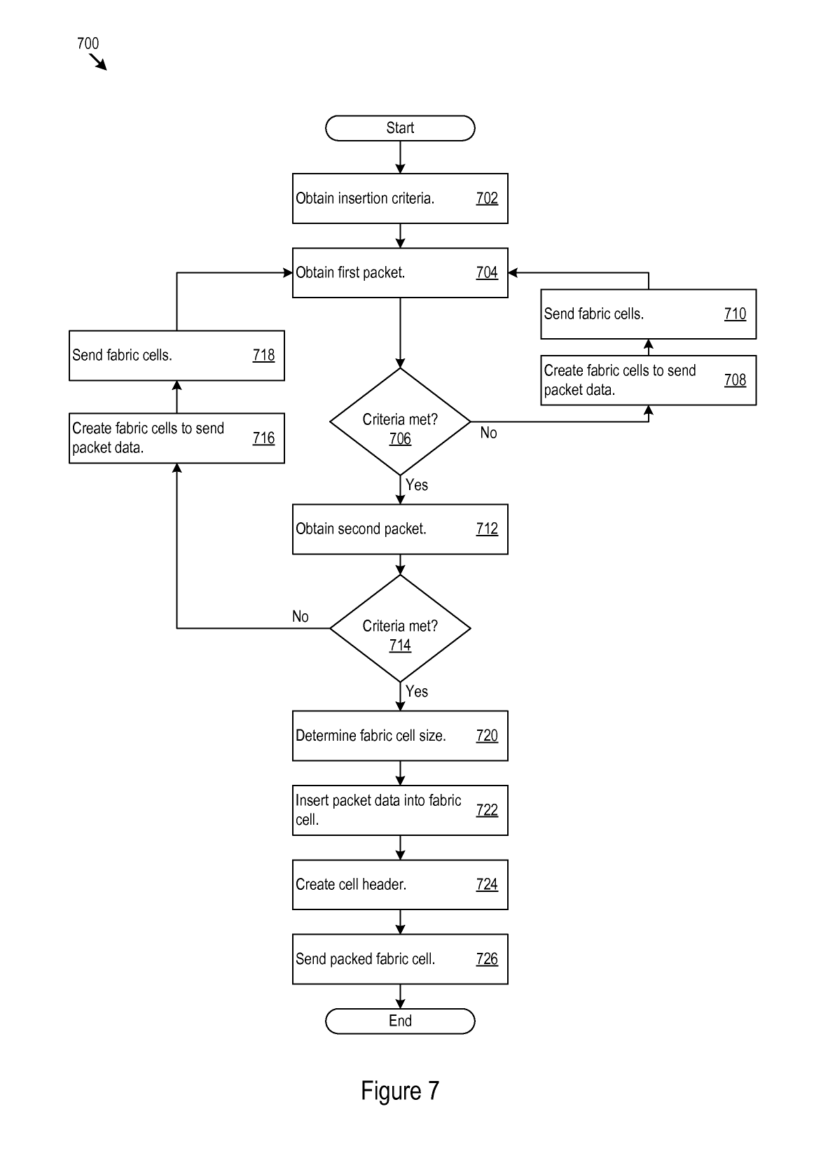

FIG. 7 shows an example of logic 700 that the line card 210 may implement as hardware, software, or both. For example, the line card 210 may implement the logic 700 as the packing logic 142. The packing logic 142 may obtain insertion criteria (702), such as the insertion criteria 163. The insertion criteria 163 may be that multiple packets or packet portions can be inserted into a fabric cell. The insertion criteria 163 may be with respect to one or more packing characteristics, a fabric cell, or both. In one implementation, the packing logic 142 may obtain packets that satisfy a packing characteristic insertion criteria by obtaining packets from any number of buffers, e.g., queues, storing packets with one or more common packing characteristics as specified by the insertion criteria 163.

The packing logic 142 may obtain a first packet (704), e.g., by receiving a packet dequeued from the queue 230. The packing logic 142 may then determine if the first packet meets an insertion criteria 163 with respect to a fabric cell (706). For example, the packing logic 142 may determine if the first packet is smaller than the maximum fabric cell size supported by a switching fabric, e.g., the switching fabric 110. If not, e.g., when the first packet is larger than the maximum support fabric cell size, the packing logic 142 may create one or more fabric cells (708) for switching data from the first packet through the switching fabric 110. For example, the packing logic 142 may insert a selected portion of the first packet into a first fabric cell and the remaining portions of the first packet into one or more other fabric cells. The packing logic 142 may then send the fabric cells for switching in the switching fabric 110 (710), e.g., via the communication interface 130.

If the first packet meets the insertion criteria, the packing logic 142 may obtain a second packet (712), e.g., the next packet from the queue 230. The packing logic 142 may determine if the first packet and the second packet together meet an insertion criteria 163 for the fabric cell (714). For example, the packing logic 142 may determine if the combined size of the first packet and the second packet does not exceed the maximum fabric cell size supported by the switching fabric 110. If the insertion criteria 163 is not met by the first and second packets together, the packing logic 142 may create fabric cells for switching data from the first packet and separate fabric cells from the second packet (716). The packing logic 142 may create a single fabric cell for the first packet when the first packet fits within a fabric cell supported by the switch fabric 110. The packing logic 142 may also create a single fabric cell for the second packet when the second packet fits within a fabric cell supported by the switch fabric 110. The packing logic 142 may create multiple fabric cells for either the first or second packet when the first or second packet do not fit within the fabric cell. In one implementation, the fabric cell(s) containing data from first packet do not include data from the second packet. The packing logic 142 may then send the fabric cells for the first and second packet for switching through the switching fabric 110 (718).

If the first and second packet together meet the insertion criteria, the packing logic 142 may determine a fabric cell size such that the first packet and second packet fit within the fabric cell (720). For example, the packing logic 142 may determine fabric cell size as the minimum fabric cell size such that the first and second packet fit within the fabric cell. Or, the packing logic 142 may determine the fabric cell size as the maximum fabric cell size supported by the switching fabric. The packing logic 142 may then insert the first packet and the second packet into the fabric cell (722). In one implementation, the packing logic 142 may insert separation data, e.g., a SerDes control word, between the first and second packet in the fabric cell. The packing logic 142 may create a cell header based on the multiple packets as well (724). Then, the packing logic 142 may send the packed fabric cell for switching through the switching fabric 110 (726).

By packing multiple packets or data from multiple packets into a fabric cell, the packing logic 142 may lower the maximum cell processing rate the switching fabric 110 is required to support. For example, by packing multiple packets or portions of multiple packets into a packed fabric cell, the packing logic 142 may reduce how many separate fabric cells are needed to transport data from the multiple packets through the switching fabric. Doing so may reduce the maximum switching rate that the switching fabric 110 is required to support, which may in turn reduce the complexity, power consumption, physical space, and processing capability required of the switching fabric 110. In one implementation, the packing logic 142 may create packed and non-packed fabric cells in a manner that is transparent to the switching fabric 110 such that no additional or altered logic is required of the switching fabric 110 to switch, e.g., route, packed fabric cells.

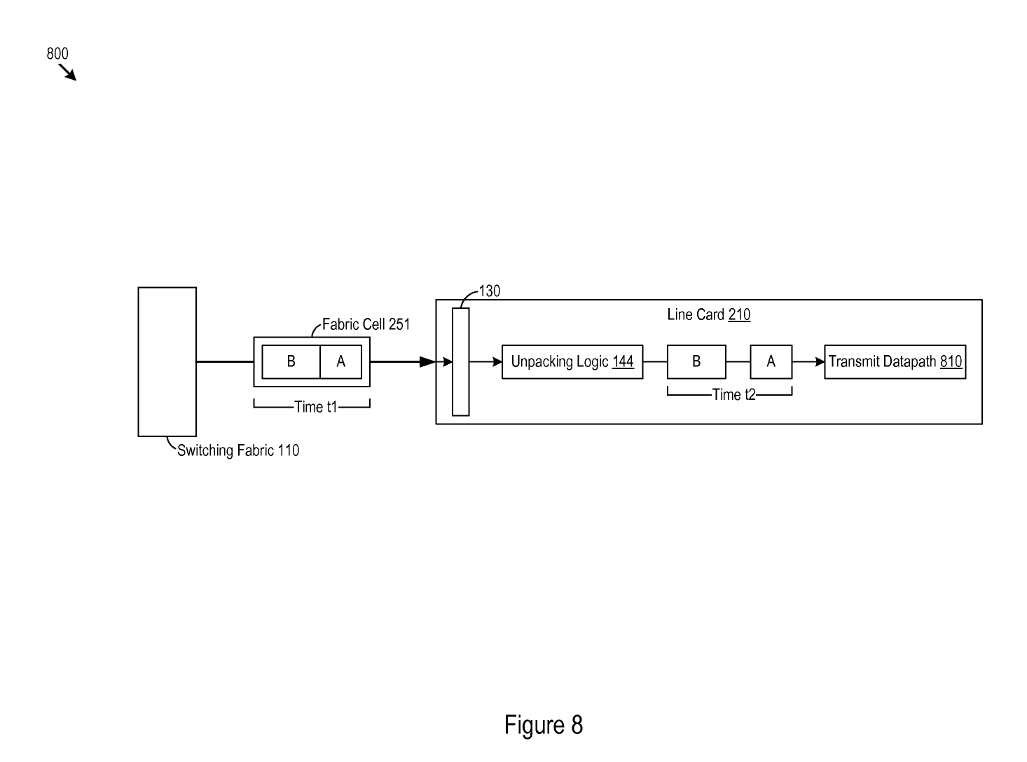

FIG. 8 shows an example of a system 800 for unpacking a fabric cell. The system 800 includes the switching fabric 110, which is in communication with the line card 210. The line card 210 may include a communication interface 130, unpacking logic 144, and a transmit datapath 810. The line card 210 may receive a fabric cell, e.g., the fabric cell 251, via the communication interface 130. The transmit datapath 810 may include any logic to process a packet prior to sending the packet to a network device communicatively coupled, e.g., interfaced, with the line card 210.

The unpacking logic 144 may obtain the fabric cell 251 to determine whether the fabric cell includes data or portions of data from multiple packets. The unpacking logic 144 may parse a fabric cell to unpack, e.g., separate, packets or portions of a data from separate packets prior to sending the packet(s) for processing by the transmit datapath 810. In one implementation, the unpacking logic 144 may determine whether the fabric cell includes data from multiple packets by analyzing any combination of fabric cell size information or packet size information. For example, the unpacking logic 144 may obtain fabric cell size information from a cell header of the fabric cell 251. The unpacking logic 144 may also obtain the fabric cell size by determining the amount of data received on a switching link before an end of cell indication is received, e.g., a SerDes end of cell control word. The fabric cell size may indicate the size of the fabric cell. The unpacking logic 144 may obtain packet size information by reading packet data from the fabric cell, which may include a packet header with packet size information.

In FIG. 8, the fabric cell 251 may include packets A and B. The unpacking logic 144 may obtain the fabric cell size of the fabric cell 251 and the packet size of packet A and perform a comparison between the two values. When the fabric cell size is greater than the packet size of packet A, the unpacking logic 144 may determine that the fabric cell 251 includes data from multiple packets. The unpacking logic 144 may obtain packet A by reading an amount of data from the fabric cell 251 equal to the packet size of packet A. The unpacking logic 144 may then determine whether subsequent data in the fabric cell is data from packet B, e.g., by reading a packet header for packet B contained in the fabric cell 251. Alternatively, the unpacking logic 144 may examine a multiple packets field in the fabric cell header to determine if multiple packets are contained in the fabric cell 251, and process the fabric cell 251 accordingly. In another implementation, the unpacking logic 144 may parse data from the fabric cell 251 and separate packet data in a fabric cell when separation data is identified, e.g., a SerDes control word inserted by the line card that sent the fabric cell 251. The unpacking logic 144 may also combine multiple fabric cells or portions from multiple fabric cells into a packet, e.g., when the packet was split into multiple fabric cells by a sending line card because the packet size exceeded the maximum fabric cell size supported by the switching fabric 110.

As seen in FIG. 8, the unpacking logic 144 may receive the fabric cell 251 that includes packets A and B after a time t1. The unpacking logic 144 may then parse the fabric cell 251 and unpack packets A and B from fabric cell 251, as seen at time t2.

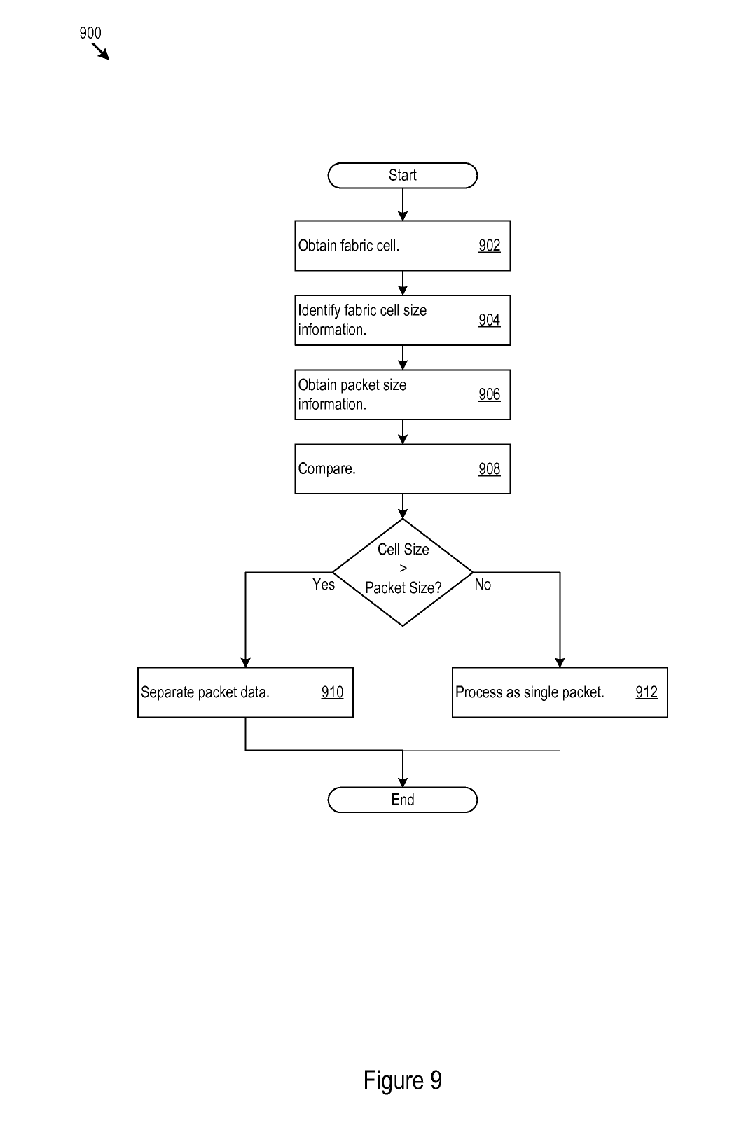

FIG. 9 shows an example of logic 900 that the line card 210 may implement as hardware, software, or both. For example, the line card 210 may implement the logic 900 as the unpacking logic 144. The unpacking logic 144 may obtain a fabric cell (902), e.g., received by the communication interface 130 from the switching fabric 110. The unpacking logic 144 may then identify fabric cell size information (904), for example from the cell header. Next, the unpacking logic 144 may obtain packet size information for a first packet (906). In one example, the unpacking logic 144 may parse the fabric cell, identify a packet header, and determine the packet size of the first packet from the packet header. If the beginning portion of the fabric cell contains a portion of data from a packet, e.g., as seen as C2 in the fabric cell 453 in FIG. 4, the unpacking logic 144 may obtain packet size information stored from processing the packet header of a previous fabric cell, e.g., the fabric cell 452 in FIG. 4 including the first portion of fabric cell C 243. Thus, the unpacking logic 144 may determine the amount of remaining packet data the fabric cell contains for the first packet. In other implementations, the unpacking logic 144 may obtain packet size information directly from the fabric cell header, which may include the number of packets in the fabric cell, the start and end positions of packets in a fabric cell, or other information.

Next, the unpacking logic 144 may determine if the fabric cell includes data from multiple packets by comparing the fabric cell size information and the first packet size information (908). If the fabric cell size exceeds the first packet size (or remaining data amount from the first packet), the unpacking logic 144 may separate the data from the first packet and next packet (910) prior to sending packet data to the transmit datapath 810. If not, the unpacking logic 144 may process the fabric cell as data from single packet (912). For example, the unpacking logic 144 may combine the packet data in the fabric cell when the unpacking logic 144 previously received data from the same packet. Or, the unpacking logic 144 may parse a packet for sending to the transmit datapath 810 when the packet fit into the fabric cell.

The methods, devices, and logic described above may be implemented in many different ways in many different combinations of hardware, software or both hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above. While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A method comprising:
determining, for a switching fabric, a fabric cell size of a fabric cell that the switching fabric communicates through the switching fabric; and
prior to switching the fabric cell through the switching fabric, inserting data from multiple packets into the fabric cell without exceeding the fabric cell size.

2. The method of claim 1, where the fabric cell size is a maximum fabric cell size supported by the switching fabric.

3. The method claim 1, where determining comprises:
choosing the fabric cell size in order to reduce how many separate fabric cells are needed to transport the data from the multiple packets through the switching fabric.

4. The method of claim 1, further comprising:
obtaining, as the multiple packets, a first packet and a second packet; and
when the first packet and the second packet meet an insertion criteria with respect to the fabric cell, inserting both the first packet and the second packet into the fabric cell.

5. The method of claim 4, where the insertion criteria comprises both the first packet and the second packet fitting within the fabric cell without exceeding the fabric cell size.

6. The method of claim 1, further comprising:
obtaining the multiple packets; and where determining comprises:
determining the fabric cell size such that the multiple packets fit within the fabric cell.

7. A device comprising:
an input buffer operable to store a first packet and a second packet;
a switch fabric in communication with the input buffer and operable to communicate a fabric cell through the switch fabric; and
processing logic in communication with the input buffer, the processing logic configured to:
determine when the first packet and the second packet meet an insertion criteria for the fabric cell; and
when the first packet and the second packet meet the insertion criteria for the fabric cell, inserting both the first packet and the second packet into the fabric cell prior to switching the fabric cell through the switch fabric.

8. The device of claim 7, where the insertion criteria comprises:
that the first packet is smaller than the fabric cell.

9. The device of claim 8, where the insertion criteria further comprises:
that the first packet and the second packet together are smaller than the fabric cell.

10. The device of claim 7, where the insertion criteria comprises:
that the first packet and second packet share a common destination port, destination device, transmission priority, or any combination thereof.

11. The device of claim 7, where the processing logic is further configured to:
create a cell header for the fabric cell based on the multiple packets in the fabric cell.

12. The device of claim 7, where the processing logic is further configured to:
when the first packet and the second packet do not meet the insertion criteria for the fabric cell:
send the first packet without the second packet in the fabric cell, when the first packet fits within the fabric cell; and
send a selected portion of the first packet using the fabric cell, when the first packet does not fit within the fabric cell.

13. A system comprising:
a processor; and
a memory comprising:
insertion criteria;
cell packing instructions that, when executed by the processor, are configured to:
obtain a first packet with a packing characteristic; and
when the first packet meets the insertion criteria:
obtain a second packet that also has the packing characteristic; and
when the first packet and the second packet together meet the insertion criteria:
obtain a packed fabric cell comprising the first packet and the second packet; and
send the packed fabric cell to a switch fabric.

14. The system of claim 13, where the insertion criteria is met when packet data does not exceed a maximum amount of data that the packed fabric cell can hold.

15. The system of claim 13, where the packing characteristic comprises a destination device, destination port, transmission priority, or any combination thereof.

16. The system of claim 13, where the memory further comprises:
a queue comprising packets meeting the packing characteristic, including the first packet and the second packet, with the second packet sequentially queued behind the first packet in the queue.

17. The system of claim 13, where the memory further comprises:
a first queue comprising packets meeting the packing characteristic, including the first packet; and
a second queue comprising packets that also meet the packing characteristic, including the second packet.

18. The system of claim 13, where the cell packing instructions are further configured to:
when the first packet does not meet the insertion criteria, send a selected portion of the first packet in a non-packed fabric cell.

19. The system of claim 13, where the cell packing instructions are further configured to:
obtain a packed fabric cell by inserting separation data between the first packet and the second packet in the packed fabric cell.

20. The system of claim 19, where the separation data comprises a serializer/deserializer (SerDes) encoded control word.
